(19) United States
(12) Patent Application Publication
(10) Pub. No.: US 2004/0119045 A1
(43) Pub. Date: Jun. 24, 2004

(54) Magnetoviscous fluid

(76) Inventors: Katsuhiko Hata, Kobe-shi (JP); Takuya Tomura, Kobe-shi (JP)

Correspondence Address: Jordan and Hamburg, 122 East 42nd street, New York, NY, 10168, US

(21) Appl. No.: 10/478,897

(22) PCT Filed: May 23, 2002
(86) PCT No.: PCT/JP02/04977

(30) Foreign Application Priority Data
May 24, 2001 (JP) 2001-155861

(51) Int. Cl. C09K 5/00

(52) U.S. Cl. 252/71

(57) ABSTRACT

The present invention has for its object to provide a magnetorheological fluid having good dispersion stability and freedom from an unwanted increase in viscosity.

A magnetorheological fluid which has a complex modulus G* of 1 to 100000 Pa and a tan δ of 0.001 to 50 at 25° C. and 10% strain.

### TECHNICAL FIELD

The present invention relates to a magnetorheological fluid having excellent dispersion stability and recoverability of magnetorheological properties and showing a long performance life.

### BACKGROUND ART

Liquid compositions called magnetorheological fluids, magnetic fluids or magnetic rheology materials, which undergo changes in flow characteristics in response to magnetic fields are known. For example, a magnetic material-containing liquid composition responding to a magnetic field was early described in the monograph No. 55-170 coauthored by J. D. Coolidge Jr. & R. W. Hallberg (p. 149-152), which appear in The Characteristics of Magnetic Fluids (published February 1955) of AIEE Transactions.

Disclosed in U.S. Pat. No. 2,661,596 is a magnetorheological fluid containing iron oleate or the like as a dispersant. Furthermore, U.S. Pat. No. 3,006,656, U.S. Pat. No. 4,604,229, Japanese Kokai Publication Sho-51-13995, and Japanese Kokai Publication Sho-51-44579, among others, describe technologies relating to magnetorheological fluids.

These magnetorheological fluids are invariably characterized in that the magnetic particles (mean diameter: several nm to 10 and odd μm) dispersed therein are oriented in externally applied magnetic fields to form chain-like clusters and, hence, gain in viscosity or even undergo gelation leading to marked changes in flow properties and yield stress.

The industrial field of application so far proposed for these magnetorheological fluids includes bearings, sealants, centering devices, speakers, clutches, brakes, dampers, shock absorbers, engine mounts, functional members of lifts, and vibration reducers for buildings.

However, in the applications calling for comparatively large changes in fluid properties and yield stress, such as clutches, brakes, dampers, shock absorbers, and vibration reducers for buildings, none have been commercially implemented.

In order that a magnetorheological fluid may express the above-mentioned properties, the magnetic particles in the fluids must have been uniformly dispersed. However, actually a good dispersion stability can hardly be imparted to the fluid because the true density of the magnetic particles is very large as compared with the density of the medium.

Generally for enhancing the dispersion stability of a magnetorheological fluid, it is instrumental to use a high viscosity medium but the use of a medium having an excessively high viscosity leads to an increased viscosity of the very magnetorheological fluid and, hence, increased difficulties in handling.

### SUMMARY OF THE INVENTION

In the above state of the art, the present invention has for its object to provide a magnetorheological fluid having good dispersion stability and freedom from an unwanted increase in viscosity.

The present invention is a magnetorheological fluid which has a complex modulus G* of 1 to 100000 Pa and a tan δ of 0.001 to 50 at 25° C. and 10% strain. The above magnetorheological fluid is preferably a magnetic particles are dispersed in a medium having a complex modulus G* of 1 to 100000 Pa and a tan δ of 0.001 to 50 at 25° C. and 10% strain. More preferably, the medium comprises at least a low-vapor-pressure oil and a smectite organic derivative.

### BRIEF DESCRIPTION OF THE DRAWINGS

FIG. 1 is a schematic illustration showing a magnetorheological properties analyzer used in the Examples.

FIG. 2 is a diagram showing an example of measurement of magnetorheological properties.

In the diagram, 1 represents a magnetorheological fluid, 2 represents a cylinder, 3 represents a piston, 4 represents an electromagnet, 5 represents a hydraulic servo tester, 6 represents a personal computer for control and measurement, 7 represents a displacement-load loop, 8 represents a displacement-load loop in a zero magnetic field, and 9 represents a displacement-load loop in a 900 Gauss magnetic field.

### DETAILED DISCLOSURE OF THE INVENTION

The present invention is now described in detail.

The inventors of the present invention found that the dispersion stability of a magnetorheological fluid can be dramatically increased without inducing a substantial gain in viscosity during service when a certain defined medium is employed and have developed the present invention.

Thus, the magnetorheological fluid of the invention is characterized in that its medium and/or the magnetorheological fluid is designed to have a complex modulus G* within the range of 1 to 100000 Pa and a tan δ within the range of 0.001 to 50 at 25° C. and 10% strain by using a specific dispersion medium and a specific additive.

When the complex modulus G* is less than 1 Pa, the low elastic modulus leads to a poor stability of the magnetorheological fluid, while the complex modulus G* exceeding 100000 Pa tends to detract from the fluidity of the magnetorheological fluid, thus interfering with handling.

Because said medium and/or said magnetorheological fluid has a small tan δ of 0.001 to 50, the magnetorheological fluid of the invention has the functional characteristic that while the viscosity of the magnetorheological fluid is high when not in use, it is low in use.

The above medium is not particularly restricted but preferably comprises at least a dispersion medium and an additive adapted to lower the tan δ of the medium and preferably essentially consists of at least a dispersion medium and an additive adapted to lower the tan δ of the medium.

The dispersion medium mentioned above is not particularly restricted but from the standpoint of long-term stability, a low-vapor-pressure oil, for instance, is used with advantage. The low-vapor-pressure oil includes but is not limited to white oil (liquid paraffin), mineral oil, spindle oil, higher alkylbenzenes, higher alkylnaphthalenes, polybutene, poly-α-olefin oils, phenyl ethers (alkyl diphenyl ethers, dialkyl tetraphenyl ethers, alkyl triphenyl ethers), dicarboxylic acid diesters (dioctyl azelate, dioctyl adipate, dioctyl sebacate, dibutyl phthalate, dihexyl maleate), polyol polyesters available from polyols and carboxylic acids (trimethylolpropane tri-n-heptyl ester, pentaerythritol tetra-n-hexyl ester, pentaerythritol tetra-2-ethylhexyl ester), phosphoric triesters (tributyl phosphate, tri-2-ethylhexyl phosphate, tricresyl phosphate, trixylyl phosphate, phosphoric triaryl esters), silicone oils such as dimethylsilicone oil, methylhydrogen polysiloxane, methylphenylsilicone oil, α-methylstyrene-modified silicone oils, alkyl-modified silicone oils, alcohol-modified silicone oils, amino-modified silicone oils, polyether-modified silicone oils, chlorinated silicones, and fluorinated silicones, and these can be used each independently or in a combination of two or more species.

The additive for lowering the tan δ of said medium includes but is not limited to organic derivatives of smectites, organic bentonite, montmorillonite, and other clay minerals, ultrafine silica, metal soaps, modified castor oil, polyamide wax series, amide wax series, polyethylene oxide series, fatty acid dimers, sulfated oils, and higher alcohol or polyether type nonionic surfactants. Among these, organic derivatives of smectites are preferred. These additives can be used each independently or in a combination of two or more species.

The formulating level of said additive for lowering the tan δ of the medium is preferably 0.1 to 20 weight parts based on 100 weight parts of the dispersion medium. If it is less than 0.1 weight part, the tan δ of the medium will not be sufficiently depressed so that the magnetorheological fluid may not show a sufficient dispersion stability. If it exceeds 20 weight parts, the complex modulus of the medium will be increased beyond 100000 Pa so that the fluidity of the magnetorheological fluid tends to be adversely affected.

The magnetorheological fluid of the invention is preferably a dispersion of magnetic particles in the above-described medium. The magnetic particles are not particularly restricted provided that the particles have magnetic properties. Thus, particles of iron, iron nitride, iron carbide, carbonyl iron, chromium dioxide, low-carbon steel, nickel, cobalt, and various iron alloys such as aluminum-containing iron alloy, silicon-containing iron alloy, cobalt-containing iron alloy, nickel-containing iron alloy, vanadium-containing iron alloy, molybdenum-containing iron alloy, chromium-containing iron alloy, tungsten-containing iron alloy, manganese-containing iron alloy, copper-containing iron alloy, etc. and particles comprising mixtures thereof can be mentioned, for instance.

The particle diameter of said magnetic particles is preferably 0.01 to 100 μm. If it is smaller than 0.01 μm, a sufficiently large viscosity gain may not be expected on application of a magnetic field because of the small particle size. If the particles diameter exceeds 100 μm, the magnetic particles are liable to settle in the medium, thus frustrating an endeavor to attain dispersion stability. The more preferred particle diameter range is 0.5 to 20 μm.

The formulating level of said magnetic particles is preferably 10 to 90 weight % based on the whole magnetorheological fluid. If the level is below 10 weight %, the resulting magnetorheological fluid may gain only a little in viscosity on application of a magnetic field. If it exceeds 90 weight %, the magnetorheological fluid tends to have a poor fluidity. The more preferred formulating range is 50 to 85 weight %.

In the magnetorheological fluid according to the invention, a dispersant may be incorporated for enhancing the dispersibility of magnetic particles within the range which is not detrimental to characteristics of the medium. The dispersant is not particularly restricted but includes perfluoroethercarboxylates, perfluorocarboxamides, oleic acid, stearic acid, palmitic acid, lauric acid, linoleic acid, linolenic acid, erucic acid, myristic acid, sodium oleate, potassium oleate, ammonium oleate, sodium stearate, sodium palmitate, potassium laurate, sodium erucate, sodium myristate, potassium myristate, sodium behenate, polyoxyethylene sorbitan ester, dialkoxysulfosuccinates, polyoxyethylene alkylary ethers, polyoxyethylene alkyl esters, sulfuric acid esters of alcohols, alkylbenzenesulfonic acids, phosphates, polyoxyethylenealkylamines, glycerin esters, aminoalcohol esters, and silane coupling agents represented by the following formula (1). These dispersants may be used each independently or in a combination of two or more species.

CₐH₂ₐ₊₁—(Y)—SiR_{3-b}L_{b} (1)

In the formula (1), Y represents (CH₂)ₖ or C₆H₄CH₂CH₂; k represents an integer of 1 to 4; R represents an alkyl group (e.g. methyl, ethyl, propyl, butyl, etc.); L represents halogen, hydroxy, alkoxy (e.g. methoxy, ethoxy, propoxy, butoxy, etc.), or acyloxy (formyl, acetoxy, propionyloxy, butyryloxy, etc.); a represents an integer of 1 to 20; b represents an integer of 1 to 3.

The method of dispersing additive for lowering the tan δ of the medium or the magnetic particles in the medium is not particularly restricted. An exemplary method comprises adding said additive for depressing the tan δ of the medium or said magnetic particles to the medium and blending them by means of a dispersing machine such as a homogenizer, a ball mill, a sand mill, a 3-roll mill, or the like.

The magnetorheological fluid according to the invention may be supplemented, unless its magnetorheological properties are materially affected, with various additives such as the oxidation inhibitor, aging inhibitor or other stabilizer, antiseptic, viscosity modifier, flame retardant, and surfactant.

### BEST MODES FOR CARRYING OUT THE INVENTION

The present invention is further detailed in the following examples, which are not intended to restrict the present invention.

1. Preparation of Magnetorheological Fluids

### EXAMPLE 1

According to the recipe shown in Table 1, a magnetorheological fluid was prepared. The medium was prepared by blending dioctyl phthalate (DOP, product of Sanken Kako, viscosity 80 cP (20° C.)) with smectite organic derivative (product of RHEOX, Bentone 34) and methanol (reagent special grade) in the order mentioned and stirring the mixture with a homogenizer at 3000 rpm for 10 minute. In a predetermined amount of a solution of the dispersant stearic acid (reagent special grade) was dissolved in toluene, were immersed magnetic particles (product of BASF, carbonyl-iron powder CM), and after the toluene was volatilized, the particles were preliminarily mixed with the medium. A pot having an inside diameter of 90 mm and a capacity of 900 mL was charged with the above premix up to the 200 mL level. Then, 2000 g of ½-inch steel balls were placed in the pot and the pot was spun on a ball-mill turntable at 100 rpm for 24 hours to prepare a magnetorheological fluid.

### EXAMPLE 2

A magnetorheological fluid was prepared in the same manner as in Example 1 except for using polybutene (product of NOF Corporation, Polyvis ON, viscosity 30 cP (40° C.)) as the medium.

### EXAMPLE 3

A magnetorheological fluid was prepared in the same manner as in Example 2 except that magnetic particles (product of BASF, carbonyl-iron powder CM) were admixed following preparation of the medium.

### COMPARATIVE EXAMPLE 1

The dispersant stearic acid (reagent special grade) was dissolved in polybutene (product of NOF Corporation, Polyvis ON, viscosity 30 cP (40° C.)) at 70° C. in advance and magnetic particles (product of BASF, carbonyl-ion particles CM) were then admixed. A pot having an inside diameter of 90 mm and a capacity of 900 mL was charged with the above mixture up to the 200 mL level. Then, 2000 g of ½-inch steel balls were placed in the pot and the pot was spun on a ball-mill turntable at 100 rpm for 24 hours to prepare a magnetorheological fluid.

### COMPARATIVE EXAMPLE 2

A magnetorheological fluid was prepared in the same manner as in Comparative Example 1 except for using polybutene (product of NOF Corporation, Polyvis 3N, viscosity 2500 cP (40° C.)) as the dispersion medium.

### COMPARATIVE EXAMPLE 3

The medium was prepared by mixing silica (product of Shionogi & Co., Carplex FPS-1) with silicone oil (product of Unicar Japan, L45 (100), viscosity 100 cp (20° C.)) and stirring the mixture using a homogenizer at 3000 rpm for 10 minute. In a predetermined amount of a solution of the dispersant stearic acid (reagent special grade) was dissolved in toluene, were immersed magnetic particles, and after the toluene was volatilized, the particles were preliminarily mixed with the medium. A pot having an inside diameter of 90 mm and a capacity of 900 mL was charged with the above premix up to the 200 mL level. Then, 2000 g of ½-inch steel balls were placed in the pot and the pot was spun on a ball-mill turntable at 100 rpm for 24 hours to prepare a magnetorheological fluid.

TABLE 1

| | | | | Comparative | Comparative | Comparative |
|---|---|---|---|---|---|---|
| Recipe | Example | Example | Example | Example | Example | Example |
| (parts by weight) | 1 | 2 | 3 | 1 | 2 | 3 |
| Dispersoid | | | | | | |
| Magnetic | 74 | 74 | 79 | 70 | 70 | 74 |
| particles | | | | | | |
| Medium | | | | | | |
| DOP | 20 | — | — | — | — | — |
| Polybutene | — | 20 | 20 | 25 | — | — |
| Polybutene | — | — | — | — | 25 | — |
| Silicone oil | — | — | — | — | — | 20 |
| Smectite | 1 | 1 | 1 | — | — | — |
| organic | | | | | | |
| derivative | | | | | | |
| Methanol | 0.2 | 0.2 | 0.2 | — | — | — |
| Silica | — | — | — | — | — | 1 |
| Dispersant | | | | | | |
| Stearic acid | 5 | 5 | — | 5 | 5 | 5 |

2. Evaluation Items and Methods

The results are presented in Table 2.

(1) Viscoelastic Properties of Magnetorheological Fluids and Mediums

Using a parallel-plate viscoelasticity analyzer, the complex modulus G* and tan δ of the magnetorheological fluid and of the medium were measured under the conditions of 25° C., 10% strain, frequency 0.1 Hz.

(2) Viscous Properties at High-Speed Shear

Using a parallel-plate viscoelasticity analyzer, the steady flow viscosity of the magnetorheological fluid was measured under the conditions of 25° C., shear rate

(3) Initial Magnetorheological Properties

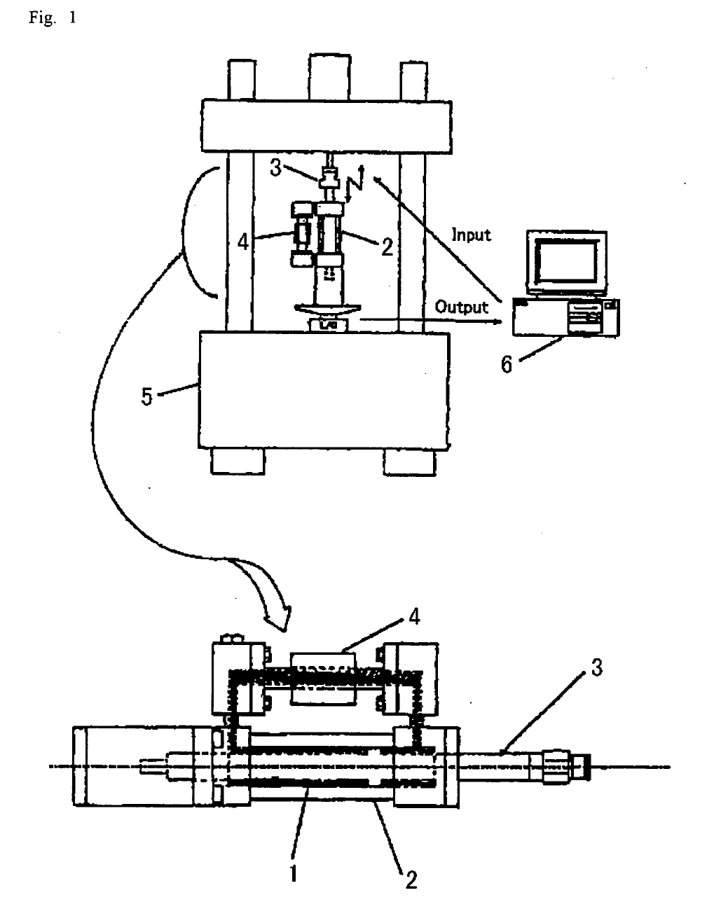

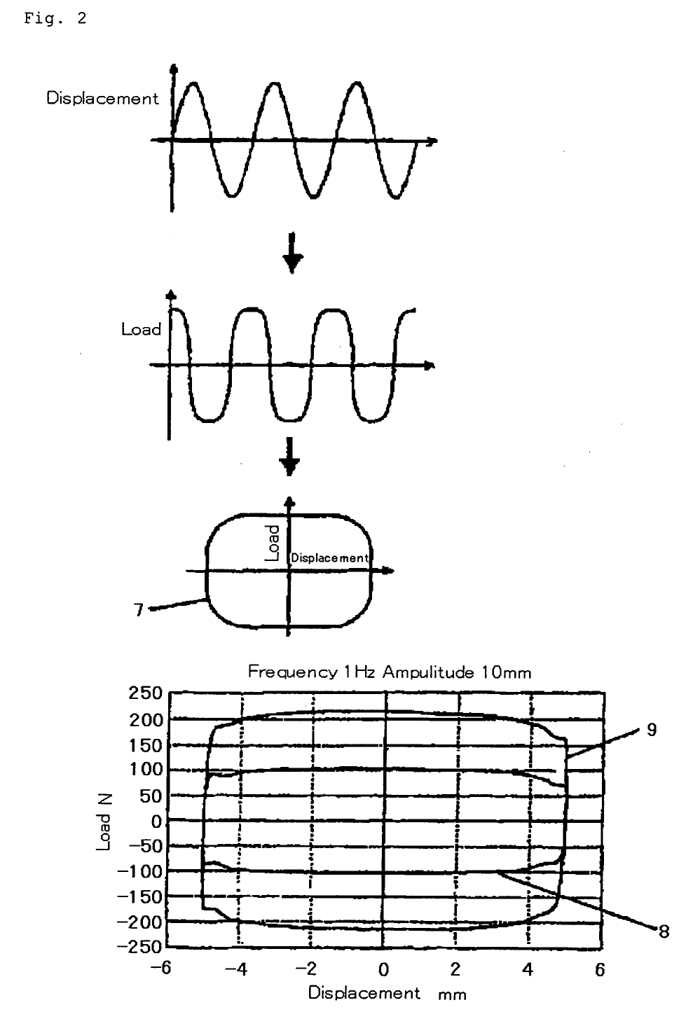

The cylinder device illustrated in FIG. 1 was filled with the magnetorheological fluid as just prepared and the amplitude-load were measured in the magnetic field of zero and 900 Gauss at the frequency of 1 Hz and the amplitude of 10 mm. An example of measurement is shown in FIG. 2.

1. The load in 0 magnetic field was recorded.

2. From the ratio of the amplitude-load loop area in 900 Gauss magnetic field to the amplitude-load loop area in 0 magnetic field, the percentage gain in the loss energy in 900 Gauss relative to the loss energy in 0 magnetic field was calculated. With any magnetorheological fluid tested, the loss energy became steady in the 3rd cycle so that the loss energy in the 3rd cycle was adopted.

In the case of Comparative Example 2, however, the fluidity of the magnetorheological fluid was so poor and the load in 0 magnetic field was over the measurement limit, no measurement could be made.

(4) Recoverability of Magnetorheological Properties

After the measurement of initial magnetic fluid properties, the cylinder device holding the magnetorheological fluid was allowed to sit at 25° C. for 3 months. After it was further allowed to stand at room temperature for 24 hours, the displacement-load loop in 0 magnetic field was measured and the number of cycles required until the loss energy had reached the value found in (3) above for the freshly prepared sample was recorded. Immediately thereafter, a magnetic field of 900 Gauss was applied and the loss energy in the 3rd cycle was measured. The percentage gain in loss energy was then calculated.

(5) Dispersion Stability (1)

In a measuring cylinder was filled with 25 mL of the magnetorheological fluid as freshly prepared, and the cylinder was allowed to sit at 25° C. for 3 months. The volume of the supernatant layer after 3 months was measured.

(6) Dispersion Stability (2)

In a measuring cylinder was filled with 25 mL of the magnetorheological fluid as freshly prepared, and the cylinder was allowed to sit at 50° C. for 3 months. The volume of the supernatant layer after 3 months was measured.

TABLE 2

| | | | | Comparative | Comparative | Comparative |
|---|---|---|---|---|---|---|
| | Example | Example | Example | Example | Example | Example |
| | 1 | 2 | 3 | 1 | 2 | 3 |
| Complex modulus G* (Pa) of | 5.3E+3 | 9.5E+3 | 1.1E+4 | 2.3E+1 | 2.3E+5 | 3.5E+1 |
| magnetorheological fluid | | | | | | |
| tan δ of magnetorheological | 3.2 | 0.8 | 0.65 | >100 | >100 | >100 |
| fluid | | | | | | |
| Complex modulus G* (Pa) | 4.7E+3 | 9.6E+3 | 9.6E+3 | <1 | 2 | 2.8E+1 |
| of medium | | | | | | |
| tan δ of medium | 10.3 | 0.7 | 0.7 | >100 | >100 | >100 |
| Steady flow viscosity at | 3.8E+0 | 5.2E+0 | 7.5E+0 | 3.2E+0 | 4.5E+2 | 4.6E+0 |
| high-speed shear (Pa·s) | | | | | | |
| Initial property - Percentage | 225 | 220 | 235 | 215 | Not | 220 |
| gain in loss energy (%) | | | | | determined | |
| Recoverability - Number of | 5 | 3 | 6 | 63 | Not | 54 |
| recovery cycles in zero | | | | | determined | |
| magnetic field | | | | | | |
| Recoverability - Percentage | 210 | 215 | 225 | 195 | Not | 205 |
| gain in loss energy (%) | | | | | determined | |
| Dispersion stability at | 6.9 | 4.5 | 5.9 | 13.2 | 4.8 | 10.3 |
| 25° C. (mL) | | | | | | |
| Dispersion stability at | — | 5.7 | 6.8 | — | 7.2 | 13.6 |
| 50° C. (mL) | | | | | | |

### Industrial Applicability

The magnetorheological fluid of the invention has an excellent dispersion stability of magnetic particles. Moreover, because of the good dispersion stability against change in temperature, this magnetorheological fluid shows little variations in properties due to environmental changes. In addition, because of the properties described above, the magnetorheological fluid has a long performance life.

1. A magnetorheological fluid
which has a complex modulus G* of 1 to 100000 Pa and a tan δ of 0.001 to 50 at 25° C. and 10% strain.

2. The magnetorheological fluid according to claim 1,
wherein a magnetic particles are dispersed in a medium having a complex modulus G* of 1 to 100000 Pa and a tan δ of 0.001 to 50 at 25° C. and 10% strain.

3. The magnetorheological fluid according to claim 2,
wherein the medium comprises at least a low-vapor-pressure oil and a smectite organic derivative.
